(19) United States
(12) Patent Application Publication
(10) Pub. No.: US 2023/0308246 A1
(43) Pub. Date: Sep. 28, 2023

(54) METHOD AND DEVICE IN NODES USED FOR WIRELESS COMMUNICATION

(71) Applicants: Lu WU, Shanghai (CN); Xiaobo ZHANG, Shanghai (CN)

(72) Inventors: Lu WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/201,189

(22) Filed: May 24, 2023

Related U.S. Application Data
(63) Continuation of application No. PCT/CN2021/132614, filed on Nov. 24, 2021.

(30) Foreign Application Priority Data
Nov. 25, 2020 (CN) 202011336017.6

(51) Int. Cl. H04L 5/00

(52) U.S. Cl. CPC H04L 5/0055

(57) ABSTRACT

The present application provides a method and device in a node for wireless communications. A first node receives a first information block; receives a first signaling; transmits a first bit block in a first radio resource group; the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index.

### CROSS REFERENCE TO RELATED APPLICATIONS

This application is the continuation of the international patent application No. PCT/CN2021/132614, filed on Nov. 24, 2021, and claims the priority benefit of Chinese Patent Application No. 202011336017.6, filed on Nov. 25, 2020, the full disclosure of which is incorporated herein by reference.

### BACKGROUND

### Technical Field

The present application relates to transmission methods and devices in wireless communication systems, and in particular to a transmission scheme and device of a control channel in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. A Work Item (WI) of NR was approved at 3GPP RAN #75th plenary to standardize NR.

In NR technology, multi-antenna (such as Multiple Input Multiple Output (MIMO), Transmission Reception Point (TRP), and multi-pannel) technology is an important component. In order to adapt to more diverse application scenarios and meet higher requirements, a further enhanced WI of MIMO under NR was approved at 3GPP RAN #86 plenary to support more robust and higher spectrum efficient, as well as multi-antenna communications for more application scenarios.

### SUMMARY

In multi-antenna systems, such as multi-Transmission Reception Point (TRP)/multi-panel communications, a same channel or signal can be transmitted through multiple TRP nodes to enhance the robustness of transmission. Multi-TRP/multi-panel transmission of a data channel is supported in release 16 (Rel-16), and 3GPP plans to introduce multi-TRP/multi-panel transmission of a control channel in Rel-17.

The present application discloses a solution for the transmission problem of a control channel in multi-antenna system. It should be noted that in the description of the present application, only a multi-antenna system, especially a multi-TRP/multi-panel transmission system, is used as a typical application scenario or example; the present application is also applicable to other scenarios facing similar problems (such as scenarios with higher requirements on robustness or coverage of a control channel, or scenarios that require PDCCH correlation other than multi-TRP/multi-panel transmission, including but not limited to coverage enhancement systems, Internet of Things (IoTs), Ultra Reliable Low Latency Communication (URLLC) networks, Internet of Vehicles (IoVs), etc.), where similar technical effects can be achieved. Additionally, the adoption of a unified solution for various scenarios, including but not limited to scenarios of multi-antenna system, contributes to the reduction of hardware complexity and costs. If no conflict is incurred, embodiments in a first node in the present application and the characteristics of the embodiments can also be applicable to a second node, and vice versa. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:

receiving a first information block;

receiving a first signaling; and

transmitting a first bit block in a first radio resource group;

herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one embodiment, a problem to be solved in the present application comprises: in order to enhance the robustness of transmission, the control channel conducts multiple transmissions through multi-TRP/multi-panel, and how to ensure that the information indicated by these multiple transmissions is consistent.

In one embodiment, a problem to be solved in the present application comprises: in order to enhance the robustness of transmission, the control channel conducts multiple transmissions through multi-TRP/multi-panel, and how to ensure that PUCCH resources indicated by these multiple transmissions are consistent.

In one embodiment, a problem to be solved in the present application comprises: in NR R15 standard, when a number of PUCCH resources is greater than 8, a first CCE index of a PDCCH candidate and its associated CORESET are used to determine PUCCH resources. How to ensure that the PUCCH resources determined by multiple transmissions are consistent when considering the control channel performing multiple transmissions through multi-TRP/multi-panel.

In one embodiment, essence of the above method comprises: the first control channel candidate and a second control channel candidate are used to schedule a same Transport Block (TB) or a Code Block Group (CBG), a first signaling is a Downlink Control Information (DCI) signaling, and a first radio resource group is a Physical Uplink Control Channel (PUCCH) resource.

In one embodiment, essence of the above method comprises: the first control channel candidate and a second control channel candidate are used to schedule a same Physical Downlink Shared Channel (PDSCH), a first signaling is a DCI signaling, and a first radio resource group is a PUCCH resource.

In one embodiment, essence of the above method comprises: the first control channel candidate and a second control channel candidate are used for two repetitions of a same DCI, a first signaling is a DCI signaling, and a first radio resource group is a PUCCH resource.

In one embodiment, advantages of adopting the above method comprise: a control channel performs multiple transmissions through multi-TRP/multi-panel, ensuring that PUCCH resources for multiple transmission indications are consistent.

In one embodiment, advantages of adopting the above method comprise: reducing the blocking probability of the control channel.

According to one aspect of the present application, the above method is characterized in that when the first value is less than the second value, the reference control channel candidate is the first control channel candidate; when the first value is greater than the second value, the reference control channel candidate is the second control channel candidate.

According to one aspect of the present application, the above method is characterized in that the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set.

According to one aspect of the present application, the above method is characterized in that the first value is a number of control channel candidate(s) associated with the first control channel candidate, and the second value is a number of control channel candidate(s) associated with the second control channel candidate.

According to one aspect of the present application, the above method is characterized in that a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

According to one aspect of the present application, the above method is characterized in that the first control channel candidate is used to determine the second parameter, or the reference control channel candidate is used to determine the second parameter.

According to one aspect of the present application, the above method is characterized in comprising:

receiving a first signal;

herein, the first signaling is used to indicate scheduling information of the first signal, and the first bit block comprises a HARQ-ACK information bit for the first signal.

The present application provides a method in a second node for wireless communications, comprising:

transmitting a first information block;

transmitting a first signaling; and

receiving a first bit block in a first radio resource group;

herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

According to one aspect of the present application, the above method is characterized in that when the first value is less than the second value, the reference control channel candidate is the first control channel candidate; when the first value is greater than the second value, the reference control channel candidate is the second control channel candidate.

According to one aspect of the present application, the above method is characterized in that the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set.

According to one aspect of the present application, the above method is characterized in that the first value is a number of control channel candidate(s) associated with the first control channel candidate, and the second value is a number of control channel candidate(s) associated with the second control channel candidate.

According to one aspect of the present application, the above method is characterized in that a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

According to one aspect of the present application, the above method is characterized in that the first control channel candidate is used to determine the second parameter, or the reference control channel candidate is used to determine the second parameter.

According to one aspect of the present application, the above method is characterized in comprising:

transmitting a first signal;

herein, the first signaling is used to indicate scheduling information of the first signal, and the first bit block comprises a HARQ-ACK information bit for the first signal.

The present application provides a first node for wireless communications, comprising:

a first receiver, receiving a first information block; receiving a first signaling; and

a first transmitter, transmitting a first bit block in a first radio resource group;

herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

The present application provides a second node for wireless communications, comprising:

a second transmitter, transmitting a first information; transmitting a first signaling; and

a second receiver, receiving a first bit block in a first radio resource group;

herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one embodiment, the method in the present application is advantageous in the following aspects:
by adopting the method in the present application, it is considered that when multiple transmissions are performed on the control channel through multi-TRP/multi-panel, the information indicated by these multiple transmissions is ensured to be consistent;
by adopting the method in the present application, it is considered that multiple transmissions are performed through multi-TRP/multi-panel, ensuring that the PUCCH resources indicated by these multiple transmissions are consistent;
by adopting the method in the present application, the blocking probability of the control channel is reduced.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block, a first signaling and a first bit block according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of determining a reference control channel candidate according to a size relation between a first value and a second value according to one embodiment of the present application;

FIG. 7 illustrates a schematic diagram of determining a reference control channel candidate according to a size relation between a first value and a second value according to another embodiment of the present application;

FIG. 8 illustrates a schematic diagram of a first value and a second value according to one embodiment of the present application;

FIG. 9 illustrates a schematic diagram of a first value and a second value according to another embodiment of the present application;

FIG. 10 illustrates a schematic diagram of a first value and a second value according to another embodiment of the present application;

FIG. 11 illustrates a schematic diagram of a first value and a second value according to another embodiment of the present application;

FIG. 12 illustrates a schematic diagram of determining a target index according to one embodiment of the present application;

FIG. 13 illustrates a schematic diagram of determining a target index according to another embodiment of the present application;

FIG. 14 illustrates a schematic diagram of determining a second parameter according to one embodiment of the present application;

FIG. 15 illustrates a structure block diagram of a processor in a first node according to one embodiment of the present application;

FIG. 16 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

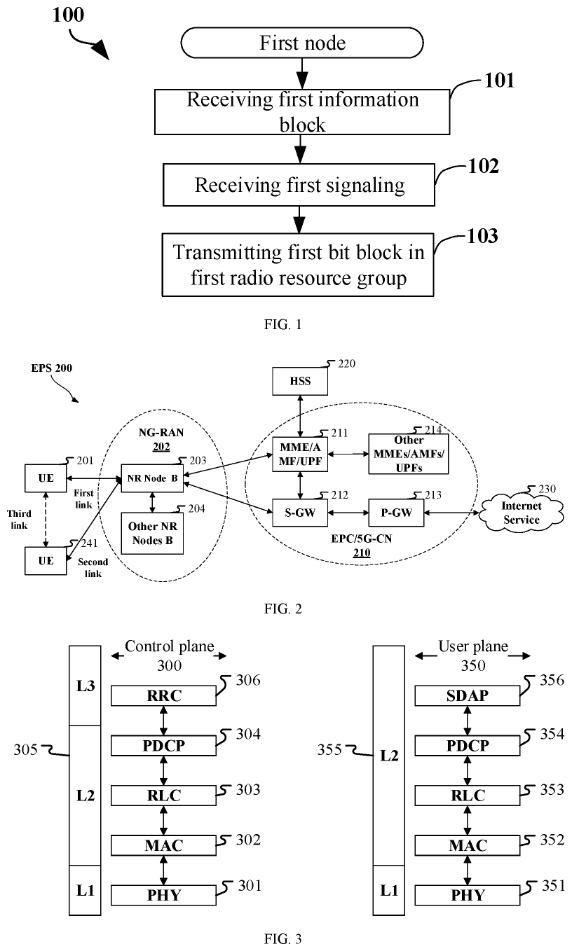

Embodiment 1 illustrates a flowchart of a first information block, a first signaling and a first bit block according to one embodiment of the present application, as shown in FIG. 1. In FIG. 1, each box represents a step. Particularly, the sequential order of steps in these boxes does not necessarily mean that the steps are chronologically arranged.

In Embodiment 1, the first node in the present application receives a first information block in step 101; receives a first signaling in step 102; transmits a first bit block in a first radio resource group in step 103; herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one embodiment, the first signaling explicitly indicates a first index.

In one embodiment, the first signaling implicitly indicates a first index.

In one embodiment, the first signaling comprises a first field, the first field in the first signaling is used to indicate a first index, and the first field comprises a positive integer number of bit(s).

In one subembodiment of the above embodiment, the first field in the first signaling explicitly indicates a first index.

In one subembodiment of the above embodiment, the first field in the first signaling implicitly indicates a first index.

In one subembodiment of the above embodiment, a first index is equal to a value of the first field in the first signaling.

In one subembodiment of the above embodiment, a value of the first field in the first signaling is used to indicate a first index.

In one embodiment, the first field is a PUCCH resource indicator field.

In one embodiment, for the specific meaning of the PUCCH resource indicator field, refer to section 7.3 in 3GPP 38.212.

In one embodiment, the first field comprises 3 bits.

In one embodiment, a number of bit(s) comprised in the first field is configured by a higher-layer signaling.

In one embodiment, a number of bit(s) comprised in the first field is related to a signaling format of the first signaling.

In one embodiment, the first index is Δ_{PRI}.

In one embodiment, for the specific meaning of the Δ_{PRI}, refer to section 9.2.3 in 3GPP 38.213.

In one embodiment, the first information block is carried by a higher-layer signaling.

In one embodiment, the first information block is carried by a Radio Resource Control (RRC) signaling.

In one embodiment, the first information block comprises one or multiple Information Elements (IEs).

In one embodiment, the first information block comprises all or a part of an IE.

In one embodiment, the first information block explicitly indicates the first radio resource set.

In one embodiment, the first information block implicitly indicates the first radio resource set.

In one embodiment, the first information block is used to indicate N radio resource sets, the first radio resource set is one of the N radio resource sets, and any of the N radio resource sets comprises a positive integer number of radio resource group(s), N being a positive integer greater than 1.

In one embodiment, the first information block comprises IE PUCCH-Config.

In one embodiment, for the specific meaning of the IE PUCCH-Config, refer to section 6.3.2 in 3GPP 38.331.

In one embodiment, the first radio resource set is a first one of the N radio resource sets.

In one embodiment, the first radio resource set is a radio resource set with a smallest index among the N radio resource sets.

In one embodiment, the first radio resource set is a radio resource set with an index of 0 among the N radio resource sets.

In one embodiment, N is equal to 4.

In one embodiment, N is not equal to 4.

In one embodiment, the N radio resource sets are respectively N Physical Uplink Control Channel (PUCCH) resource sets, and any of the N radio resource sets is a PUCCH resource.

In one embodiment, the first radio resource set is a PUCCH resource set with pucch-ResourceSetId=0.

In one embodiment, the first radio resource set is a radio resource set satisfying a first condition among the N radio resource sets; the first condition comprises: a number of the comprised radio resource group(s) is greater than a first threshold, the first threshold being a positive integer.

In one embodiment, any of the N radio resource sets is a Physical Uplink Control Channel (PUCCH) resource.

In one embodiment, the first threshold value is equal to 8.

In one embodiment, the first threshold is equal to a total number of codepoint(s) comprised in the first field.

In one embodiment, a number of bit(s) comprised in the first field is a, and the first threshold is equal to a-th power of 2, a being a positive integer.

In one embodiment, a number of bit(s) comprised in the first field is a, and a total number of codepoint(s) comprised in the first field is equal to a-th power of 2, a being a positive integer.

In one embodiment, a number of bit(s) comprised in the first field is a, and the first index is a non-negative integer less than a-th power of 2.

In one embodiment, M is not greater than 32.

In one embodiment, M is greater than 8.

In one embodiment, M is greater than the first threshold.

In one embodiment, M is R_{PUCCH}.

In one embodiment, for the specific meaning of the R_{PUCCH}, refer to section 9.2.3 in 3GPP 38.213.

In one embodiment, M is greater than a total number of codepoint(s) comprised in the first field.

In one embodiment, the first radio resource group comprises at least one of time-frequency resources or code-domain resources

In one embodiment, the first radio resource group comprises time-frequency resources.

In one embodiment, the first radio resource group comprises code-domain resources.

In one embodiment, the first radio resource group comprise time-frequency resources and code-domain resources.

In one embodiment, the second radio resource group comprises at least one of time-frequency resources or code-domain resources

In one embodiment, the second radio resource group comprises time-frequency resources.

In one embodiment, the second radio resource group comprises code-domain resources.

In one embodiment, the second radio resource group comprises time-frequency resources and code-domain resources.

In one embodiment, any of the M radio resource groups comprises at least one of time-frequency resources or code-domain resources.

In one embodiment, any of the M radio resource groups comprises time-frequency resources.

In one embodiment, any of the M radio resource groups comprises code-domain resources.

In one embodiment, any of the M radio resource groups comprises time-frequency resources and code-domain resources.

In one embodiment, any of the M radio resource groups is a Physical Uplink Control Channel (PUCCH) resource.

In one embodiment, the radio resource group comprises at least one of time-frequency resources or code-domain resources

In one embodiment, the radio resource group comprises time-frequency resources.

In one embodiment, the radio resource group comprises code-domain resources.

In one embodiment, the radio resource group comprises time-frequency resources and code-domain resources.

In one embodiment, the code-domain resources comprise one or multiple of an RS sequence, a preamble, a pseudo random sequence, a low PAPR sequence, a cyclic shift, an Orthogonal Cover Code (OCC), an orthogonal sequence, a frequency-domain orthogonal sequence and a time-domain orthogonal sequence.

In one embodiment, the first signaling is a physical-layer signaling.

In one embodiment, the first signaling is dynamically configured.

In one embodiment, the first signaling is a Downlink Control Information (DCI) signaling.

In one embodiment, the first signaling is transmitted through a Physical Downlink Control Channel (PDCCH).

In one embodiment, the first signaling schedules a Physical Downlink Shared Channel (PDSCH) for reception.

In one embodiment, the first signaling indicates a Semi-persistent scheduling (SPS) release, and the first bit block comprises a HARQ-ACK information bit of the SPS release.

In one embodiment, the first signaling indicates a Semi-persistent scheduling (SPS) PDSCH release, and the first bit block comprises a HARQ-ACK information bit of the SPS PDSCH release.

In one embodiment, the first bit block comprises a positive integer number of bit(s).

In one embodiment, the first bit block comprises Uplink Control Information (UCI).

In one embodiment, the first bit block comprises a Hybrid Automatic Repeat reQuest ACKnowledgement (HARQ-ACK) codebook.

In one embodiment, the first bit block comprises a HARQ-ACK information bit.

In one embodiment, time-frequency resources occupied by the first signaling comprise a Resource Element (RE) occupied by the first control channel candidate.

In one embodiment, the first control channel candidate comprises a positive integer number of RE(s), and the second control channel candidate comprises a positive integer number of RE(s).

In one embodiment, the first control channel candidate comprises a positive integer number of CCE(s), and the second control channel candidate comprises a positive integer number of CCE(s).

In one embodiment, the first control channel candidate is different from the second control channel candidate.

In one embodiment, at least one CCE in the first control channel candidate does not belong to the second control channel candidate.

In one embodiment, any CCE in the first control channel candidate does not belong to the second control channel candidate.

In one embodiment, an index of an initial CCE of the first control channel candidate is the same as an index of an initial CCE of the second control channel candidate.

In one embodiment, an index of an initial CCE of the first control channel candidate is different from an index of an initial CCE of the second control channel candidate.

In one embodiment, an index of an initial CCE of the first control channel candidate and an index of an initial CCE of the second control channel candidate are independently configured.

In one embodiment, an index of an initial CCE of the first control channel candidate is unrelated to an index of an initial CCE of the second control channel candidate.

In one embodiment, the first control channel candidate is a physical-layer control channel candidate, and the second control channel candidate is a physical-layer control channel candidate.

In one embodiment, the physical-layer control channel is a Physical Downlink Control CHannel (PDCCH).

In one embodiment, the physical-layer control channel is an Enhanced PDCCH (ePDCCH).

In one embodiment, the physical-layer control channel is a short PDCCH (sPDCCH).

In one embodiment, the physical layer control channel is a Narrow Band PDCCH (NB-PDCCH).

In one embodiment, the first control channel candidate is a Physical Downlink Control Channel (PDCCH) candidate, and the second control channel candidate is a Physical Downlink Control Channel (PDCCH) candidate.

In one embodiment, the first control channel candidate is a Monitored PDCCH Candidate, and the second control channel candidate is a Monitored PDCCH Candidate.

In one embodiment, the first control channel candidate occupies a positive integer number of Control Channel Element(s) (CCE(s)), and the second control channel candidate occupies a positive integer number of CCE(s).

In one embodiment, a number of CCE(s) occupied by the first control channel candidate is equal to one of 1, 2, 4, 8, and 16, and a number of CCE(s) occupied by the second control channel candidate is equal to one of 1, 2, 4, 8 and 16.

In one embodiment, the first control channel candidate and the second control channel candidate respectively occupy different CCEs.

In one embodiment, a CCE comprises 9 Resource Element Groups (REGs), and an REG comprises 4 REs.

In one embodiment, an CCE comprises 6 REGs, and an REG comprises 12 REs.

In one embodiment, a Quasi Co-Location (QCL) parameter of the first control channel candidate and a QCL parameter of the second control channel candidate are different.

In one embodiment, a reference signal comprised in the first control channel candidate and a reference signal comprised in the second control channel candidate are not QCL.

In one embodiment, a reference signal comprised in the first control channel candidate is a Demodulation Reference Signal (DMRS), and a reference signal comprised in the second control channel candidate is a DMRS.

In one embodiment, a reference signal comprised in the first control channel candidate is a PDCCH DMRS, and a reference signal comprised in the second control channel candidate is a PDCCH DMRS.

In one embodiment, a reference signal comprised in the first control channel candidate and a reference signal comprised in the second control channel candidate are respectively QCL with different reference signals.

In one embodiment, a reference signal comprised in the first control channel candidate and a reference signal comprised in the second control channel candidate are respectively QCL with different antenna ports.

In one embodiment, a reference signal comprised in the first control channel candidate and a reference signal comprised in the second control channel candidate are respectively QCL with reference signals occupying different time-frequency resources.

In one embodiment, the first node in the present application assumes that a QCL parameter of the first control channel candidate and a QCL parameter of the second control channel candidate are different.

In one embodiment, the first node in the present application cannot assume that a QCL parameter of the first control channel candidate and a QCL parameter of the second control channel candidate are the same.

In one embodiment, the first node in the present application assumes that a reference signal comprised in the first control channel candidate and a reference signal comprised in the second control channel candidate are not QCL.

In one embodiment, the first node in the present application cannot assume that a reference signal comprised in the first control channel candidate and a reference signal comprised in the second control channel candidate are QCL.

In one embodiment, a Transmission Configuration Indication (TCI) state of the first control channel candidate and a TCI of the second control channel candidate are not the same.

In one embodiment, a TCI state of a reference signal comprised in the first control channel candidate and a TCI state of a reference signal comprised in the second control channel candidate are not the same.

In one embodiment, the first node in the present application assumes that a TCI state of the first control channel candidate and a TCI state of the second control channel candidate are not the same.

In one embodiment, the first node in the present application cannot assume that a TCI state of the first control channel candidate and a TCI state of the second control channel candidate are the same.

In one embodiment, the first node in the present application assumes that a TCI state of a reference signal comprised in the first control channel candidate and a TCI state of a reference signal comprised in the second control channel candidate are not the same.

In one embodiment, the first node in the present application cannot assume that a TCI state of a reference signal comprised in the first control channel candidate and a TCI state of a reference signal comprised in the second control channel candidate are the same.

In one embodiment, the first TCI state is a TCI state of the first control channel candidate, and the second TCI state is a TCI state of the second control channel candidate.

In one embodiment, the first TCI state is a TCI state of the first control resource set, and the second TCI state is a TCI state of the second control resource set.

In one embodiment, the first TCI state and the second TCI state are not the same.

In one embodiment, the first TCI state and the second TCI state are the same.

In one embodiment, a first TCI state is used to monitor the first control channel candidate, and a second TCI state is used to monitor the first control channel candidate.

In one embodiment, a first TCI state is used to monitor the first control resource set, and a second TCI state is used to monitor the second control resource set.

In one embodiment, a QCL type of a reference signal comprised in the first control channel candidate and a QCL type of a reference signal comprised in the second control channel candidate are different.

In one embodiment, a QCL type of a reference signal comprised in the first control channel candidate and a QCL type of a reference signal comprised in the second control channel candidate are the same.

In one embodiment, both a QCL type of a reference signal comprised in the first control channel candidate and a QCL type of a reference signal comprised in the second control channel candidate comprise QCL-TypeD.

In one embodiment, the first value is different from the second value.

In one embodiment, the first value is a positive integer, and the second value is a positive integer.

In one embodiment, whether a reference control channel candidate is the first control channel candidate or the second control channel candidate is determined according to a size relation of the first value and a second value.

In one embodiment, the target index has a functional relation with the first parameter and the first index.

In one embodiment, the target index has a mapping relation with the first parameter and the first index.

In one embodiment, the first parameter, the first index and M are used together to determine a target index.

In one embodiment, the first parameter, the second parameter, the first index and M are used together to determine a target index.

In one embodiment, the target index is r_{PUCCH}.

In one embodiment, for the specific meaning of the r_{PUCCH}, refer to section 9.2.3 in 3GPP 38.213.

In one embodiment, the target index is a non-negative integer less than M.

In one embodiment, the target index is an index of the first radio resource group in the first radio resource set.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MIME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 241 corresponds to the second node in the present application.

In one embodiment, the gNB 203 corresponds to the second node in the present application.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC sublayer 306.

In one embodiment, the first information block in the present application is generated by the RRC sublayer 306.

In one embodiment, the first signaling in the present application is generated by the PHY 301.

In one embodiment, the first signaling in the present application is generated by the PHY 351.

In one embodiment, the first signal in the present application is generated by the PHY 301.

In one embodiment, the first signal in the present application is generated by the PHY 351.

In one embodiment, the first bit block in the present application is generated by the PHY 301.

In one embodiment, the first bit block in the present application is generated by the PHY 351.

### Embodiment 4

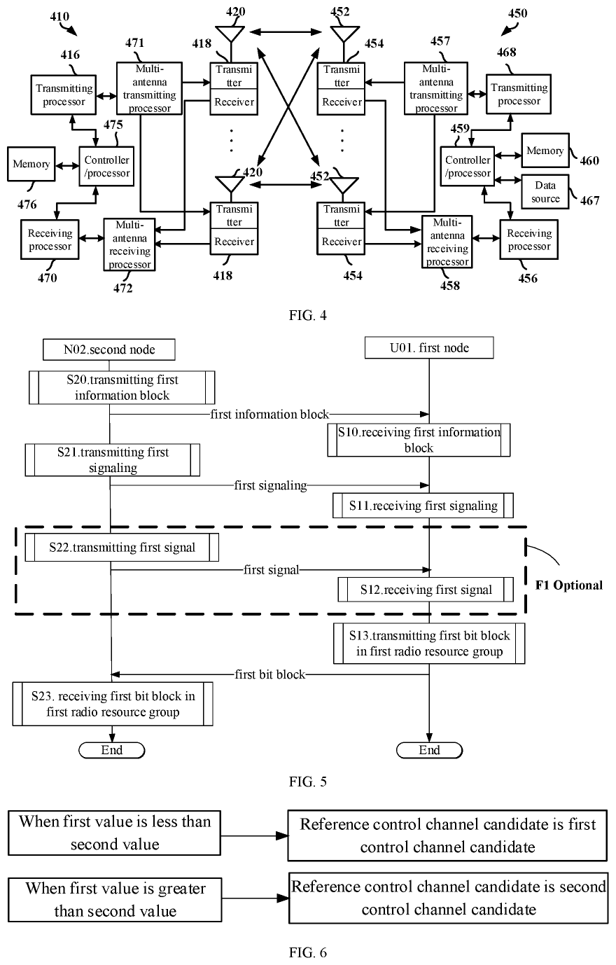

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first information block; receives a first signaling; transmits a first bit block in a first radio resource group; herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first information block; receiving a first signaling; transmitting a first bit block in a first radio resource group; herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first information block; transmits a first signaling; receives a first bit block in a first radio resource group; herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first information block; transmitting a first signaling; receiving a first bit block in a first radio resource group; herein, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460 or the data source 467 is used to receive the first information block in the present application.

In one embodiment, at least one of the antenna 420, the transmitter 418, the multi-antenna transmitting processor 471, the transmitting processor 416, the controller/processor 475 or the memory 476 is used to transmit the first information block in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the receiver 454, the multi-antenna receiving processor 458, the receiving processor 456, the controller/processor 459, the memory 460, or the data source 467 is used to receive the first signal in the present application.

In one embodiment, at least one of the antenna 420, the transmitter 418, the multi-antenna transmitting processor 471, the transmitting processor 416, the controller/processor 475, or the memory 476 is used to transmit the first signal in the present application.

In one embodiment, at least one of the antenna 452, the transmitter 454, the multi-antenna transmitting processor 458, the transmitting processor 468, the controller/processor 459, the memory 460, or the data source 467 is used to transmit the first bit block in the present application in the first radio resource group in the present application.

In one embodiment, at least one of the antenna 420, the receiver 418, the multi-antenna receiving processor 472, the receiving processor 470, the controller/processor 475, or the memory 476 is used to receive the first bit block in the present application in the first radio resource group in the present application.

### Embodiment 5

Embodiment 5 illustrates a flowchart of radio signal transmission according to one embodiment in the present application, as shown in FIG. 5. In FIG. 5 a first node U01 and a second node N02 are in communications via an air interface. In FIG. 5, steps in dotted box F1 are optional.

The first node U01 receives a first information block in step S10; receives a first signaling in step S11; receives a first signal in step S12; transmits a first bit block in a first radio resource group in step S13;

The second node N02 transmits a first information block in step S20; transmits a first signaling in step S21; transmits a first signal in step S22; receives a first bit block in a first radio resource group in step S23.

In embodiment 5, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used by the first node U01 to determine a first parameter, the first signaling is used to indicate a first index, the first parameter and the first index are used together by the first node U01 to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer; the first signaling is used to indicate scheduling information of the first signal, and the first bit block comprises a HARQ-ACK information bit for the first signal.

In one embodiment, the reference control channel candidate is used by the second node N02 to determine a first parameter.

In one embodiment, the first parameter and the first index are used together by the second node N02 to determine a target index.

In one embodiment, when the first signaling indicates a Semi-persistent scheduling (SPS) release, the dotted box F1 does not exist.

In one embodiment, when the first signaling indicates a Semi-persistent scheduling (SPS) PDSCH release, the dotted box F1 does not exist.

In one embodiment, the first receiver monitors the first control channel candidate.

In one embodiment, the first receiver monitors the second control channel candidate.

In one embodiment, the first receiver also monitors a control channel candidate other than the first control channel candidate.

In one embodiment, the first receiver also monitors a control channel candidate other than the first control channel candidate and the second control channel candidate.

In one embodiment, the first receiver monitors at least the first control channel candidate in the first control channel candidate and the second control channel candidate.

In one embodiment, a start time of the second control channel candidate is later than a start time of the first control channel candidate, and the first receiver drops monitoring the second control channel candidate.

In one embodiment, a start time of the second control channel candidate is later than a start time of the first control channel candidate, and the first receiver monitors the second control channel candidate.

In one embodiment, a start time of the second control channel candidate is later than a start time of the first control channel candidate, and whether the first receiver monitors the second control channel candidate is implementation related to the first node.

In one embodiment, a start time of the second control channel candidate is later than a start time of the first control channel candidate, and the first node determines whether to monitor the second control channel candidate by itself.

In one embodiment, the meaning of the phrase of “monitoring the first control channel candidate” comprises: performing decoding on the first control channel candidate.

In one embodiment, the meaning of the phrase of “monitoring the second control channel candidate” comprises: performing decoding on the second control channel candidate.

In one embodiment, the meaning of the phrase of “monitoring the first control channel candidate” comprises: performing blind decoding on the first control channel candidate.

In one embodiment, the meaning of the phrase of “monitoring the second control channel candidate” comprises: performing blind decoding on the second control channel candidate.

In one embodiment, the meaning of the phrase of “monitoring the first control channel candidate” comprises: performing decoding and CRC check on the first control channel candidate.

In one embodiment, the meaning of the phrase of “monitoring the second control channel candidate” comprises: performing decoding and CRC check on the second control channel candidate.

In one embodiment, the meaning of the phrase of “monitoring the first control channel candidate” comprises: performing decoding and a CRC check scrambled by an RNTI on the first control channel candidate.

In one embodiment, the meaning of the phrase of “monitoring the second control channel candidate” comprises: performing decoding and a CRC check scrambled by an RNTI on the second control channel candidate.

In one embodiment, the meaning of the phrase of “monitoring the first control channel candidate” comprises: performing decoding on the first control channel candidate based on monitored Downlink Control Information (DCI) Format(s).

In one embodiment, the meaning of the phrase of “monitoring the second control channel candidate” comprises: performing decoding on the second control channel candidate based on monitored DCI Format(s).

In one embodiment, the meaning of the phrase of “monitoring the first control channel candidate” comprises: performing decoding on the first control channel candidate based on one or multiple monitored DCI Formats.

In one embodiment, the meaning of the phrase of “monitoring the second control channel candidate” comprises: performing decoding on the second control channel candidate based on one or multiple monitored DCI Formats.

In one embodiment, the first control channel candidate being associated with a second control channel candidate is pre-defined.

In one embodiment, the first control channel candidate being associated with a second control channel candidate is pre-configured.

In one embodiment, the first control channel candidate being associated with a second control channel candidate is configured by a higher-layer signaling.

In one embodiment, a control channel candidate associated with the first control channel candidate is pre defined, and a control channel candidate associated with the second control channel candidate is pre-defined.

In one embodiment, a control channel candidate associated with the first control channel candidate is pre-configured, and a control channel candidate associated with the second control channel candidate is pre-configured.

In one embodiment, a control channel candidate associated with the first control channel candidate is configured by a higher-layer signaling, and a control channel candidate associated with the second control channel candidate is configured by a higher-layer signaling.

In one embodiment, the first receiver receives a second information block; herein, the second information block is used to determine that the first control channel candidate is associated with a second control channel candidate.

In one embodiment, the second information block is used to determine a control channel candidate associated with the first control channel candidate and a control channel candidate associated with the second control channel candidate.

In one embodiment, the second information block is used to indicate that the first control channel candidate is associated with a second control channel candidate.

In one embodiment, the second information block explicitly indicates that the first control channel candidate is associated with a second control channel candidate.

In one embodiment, the second information block implicitly indicates that the first control channel candidate is associated with a second control channel candidate.

In one embodiment, the second information block is used to indicate that a first search space is associated with a second search space, the first control channel candidate belongs to the first search space, and the second control channel candidate belongs to the second search space.

In one embodiment, the second information block is used to indicate that a first control channel candidate set is associated with a second control channel candidate set, the first control channel candidate belongs to the first control channel candidate set, and the second control channel candidate belongs to the second control channel candidate set; the first control channel candidate set comprises a positive integer number of control channel candidate(s), and the second control channel candidate set comprises a positive integer number of control channel candidate(s).

In one embodiment, the second information block comprises IE PDCCH-Config.

In one embodiment, the second information block comprises an IE SearchSpace.

In one embodiment, the second information block comprises an IE ControlResourceSet.

In one embodiment, for the specific meaning of the IE PDCCH-Config, refer to section 9.2.3 in 3GPP 38.213.

In one embodiment, for the specific meaning of the IE SearchSpace, refer to section 9.2.3 in 3GPP 38.213.

In one embodiment, for the specific meaning of the IE ControlResourceSet, refer to section 9.2.3 in 3GPP 38.213.

In one embodiment, the first control channel candidate and the second control channel candidate have a same scrambling code.

In one embodiment, the first control channel candidate and the second control channel candidate have different scrambling codes.

In one embodiment, a first scrambling sequence is a scrambling sequence of a PDCCH carried by the first control channel candidate, and a second scrambling sequence is a scrambling sequence of a PDCCH carried by the second control channel candidate.

In one embodiment, the first node assumes that a third bit block is used to generate a physical channel carried by the first control channel candidate after being scrambled by a first scrambling sequence, and the first node assumes that a fourth bit block is used to generate a physical channel carried by the second control channel candidate after being scrambled by a second scrambling sequence; the third bit block comprises more than one bit, and the fourth bit block comprises more than one bit.

In one subembodiment of the above embodiment, the third bit block is an output after a DCI is through channel coding and rate matching, and the fourth bit block is an output after a DCI is through channel coding and rate matching.

In one subembodiment of the above embodiment, the third bit block is scrambled by the first scrambling sequence before being modulated, and the fourth bit block is scrambled by the first scrambling code sequence before being modulated.

In one subembodiment of the above embodiment, the third bit block generates a physical channel carried by the first control channel candidate after sequentially through scrambling of the first scrambling sequence, modulation, Mapping to physical resources, Orthogonal Frequency Division Multiplexing (OFDM) baseband signal generation, Modulation and Upconversion; the fourth bit block generates a physical channel carried by the second control channel candidate after sequentially through scrambling of the second scrambling sequence, modulation, Mapping to physical resources, OFDM baseband signal generation, Modulation and Upconversion.

In one subembodiment of the above embodiment, the third bit block is the same as the fourth bit block.

In one subembodiment of the above embodiment, the third bit block is different from the fourth bit block.

In one embodiment, the meaning of the phrase that “the first control channel candidate and the second control channel candidate have a same scrambling code” comprises the following meaning: the first scrambling sequence is the same as the second scrambling sequence.

In one embodiment, the meaning of the phrase that “the first control channel candidate and the second control channel candidate have a same scrambling code” comprises the following meaning: elements in the first scrambling sequence respectively correspond to elements in the second scrambling sequence.

In one embodiment, the phrase that “the first control channel candidate and the second control channel candidate have a same scrambling code” comprises the following meaning: an initial value of a Generator of the first scrambling sequence is the same as an initial value of a Generator of the second scrambling sequence.

In one embodiment, the meaning of the phrase that “the first control channel candidate and the second control channel candidate have a same scrambling code” comprises the following meaning: the first node in the present application assumes that the first control channel candidate and the second control channel candidate have a same scrambling code.

In one embodiment, the meaning of the phrase that “the first control channel candidate and the second control channel candidate have a same scrambling code” comprises the following meaning: an initial value of a generate register of the first scrambling sequence is the same as an initial value of a generate register of the second scrambling sequence.

In one embodiment, the meaning of the phrase that “the first control channel candidate and the second control channel candidate have a same scrambling code” comprises the following meaning: a same Gold sequence with a length of 31 using a same generator initial value to generate the first scrambling sequence and the second scrambling sequence.

In one embodiment, the meaning of the phrase that “the first control channel candidate and the second control channel candidate have different scrambling codes” comprises the following meaning: the first scrambling sequence is different from the second scrambling sequence.

In one embodiment, the phrase that “the first control channel candidate and the second control channel candidate have different scrambling codes” comprises the following meaning: an initial value of a Generator of the first scrambling sequence is different from an initial value of a Generator of the second scrambling sequence.

In one embodiment, the meaning of the phrase that “the first control channel candidate and the second control channel candidate have different scrambling codes” comprises the following meaning: the first node in the present application assumes that the first control channel candidate and the second control channel candidate have different scrambling codes.

In one embodiment, the meaning of the phrase that “the first control channel candidate and the second control channel candidate have different scrambling codes” comprises the following meaning: an initial value of a generate register of the first scrambling sequence is different from an initial value of a generate register of the second scrambling sequence.

In one embodiment, the meaning of the phrase that “the first control channel candidate and the second control channel candidate have different scrambling codes” comprises the following meaning: a same Gold sequence with a length of 31 using different generator initial values to generate the first scrambling sequence and the second scrambling sequence.

In one embodiment, “a first given control channel candidate being associated with a second given control channel candidate” comprises the following meaning: the first given control channel candidate and the second given control channel candidate have a same scrambling code.

In one embodiment, the first given control channel candidate is the first control channel candidate, and the second given control channel candidate is the second control channel candidate.

In one embodiment, the first given control channel candidate is the first control channel candidate, and the second given control channel candidate is a control channel candidate associated with the first control channel candidate.

In one embodiment, the first given control channel candidate is the second control channel candidate, and the second given control channel candidate is a control channel candidate associated with the second control channel candidate.

In one embodiment, “a first given control channel candidate being associated with a second given control channel candidate” comprises the following meaning: the first node in the present application does not expect that the second given control channel candidate comprises the first given control channel candidate.

In one embodiment, “a first given control channel candidate being associated with a second given control channel candidate” comprises the following meaning: a size of a format of a DCI carried by the first given control channel candidate is the same as a size of a format of a DCI carried by the second given control channel candidate.

In one embodiment, “a first given control channel candidate being associated with a second given control channel candidate” comprises the following meaning: a search space set to which the first given control channel candidate is associated with a search space set to which the second given control channel candidate belongs.

In one embodiment, “a first given control channel candidate being associated with a second given control channel candidate” comprises the following meaning: a search space set to which the first given control channel candidate belongs is the same as a search space set to which the second given control channel candidate belongs.

In one embodiment, “a first given control channel candidate being associated with a second given control channel candidate” comprises the following meaning: a CORESET associated with the first given control channel candidate is associated with a CORESET associated with the second given control channel candidate.

In one embodiment, “a first given control channel candidate being associated with a second given control channel candidate” comprises the following meaning: a TCI state of the first given control channel candidate and a TCI state of the second given control channel candidate are two TCI states used by a same CORESET.

In one embodiment, “a first given control channel candidate being associated with a second given control channel candidate” comprises the following meaning: the first given control channel candidate and the second given control channel candidate are associated with a same CORESET.

In one embodiment, “a first given control channel candidate being associated with a second given control channel candidate” comprises the following meaning: the first given control channel candidate and the second given control channel candidate respectively use different TCI states of a same CORESET.

In one embodiment, “a first given control channel candidate being associated with a second given control channel candidate” comprises the following meaning: the first node assumes that a same bit block is used to generate a physical channel carried by the first given control channel candidate and a physical channel carried by the second given control channel candidate.

In one embodiment, “a first given control channel candidate being associated with a second given control channel candidate” comprises the following meaning: there exist overlapping time-domain resources between time-domain resources indicated by a DCI carried by the first given control channel candidate and time-domain resources indicated by a DCI carried by the second given control channel candidate.

In one embodiment, “a first given control channel candidate being associated with a second given control channel candidate” comprises the following meaning: the first node assumes that there exist overlapping time-domain resources between time-domain resources indicated by a DCI carried by the first given control channel candidate and time-domain resources indicated by a DCI carried by the second given control channel candidate.

In one embodiment, “a first given control channel candidate being associated with a second given control channel candidate” comprises the following meaning: both a DCI carried by the first given control channel candidate and a DCI carried by the second given control channel candidate indicate a same time-frequency resource block.

In one embodiment, “a first given control channel candidate being associated with a second given control channel candidate” comprises the following meaning: the first node assumes that both a DCI carried by the first given control channel candidate and a DCI carried by the second given control channel candidate indicate a same time-frequency resource block.

In one embodiment, “a first given control channel candidate being associated with a second given control channel candidate” comprises the following meaning: both a DCI carried by the first given control channel candidate and a DCI carried by the second given control channel candidate are used to schedule a same signal or channel.

In one embodiment, “a first given control channel candidate being associated with a second given control channel candidate” comprises the following meaning: the first node assumes that both a DCI carried by the first given control channel candidate and a DCI carried by the second given control channel candidate are used to schedule a same signal or channel.

In one embodiment, the meaning of the phrase that “the first control channel candidate and a second control channel candidate are associated” comprises the following meaning: both a DCI carried by the first control channel candidate and a DCI carried by the second control channel candidate are used to schedule the first signal.

In one embodiment, the meaning of the phrase that “the first control channel candidate and a second control channel candidate are associated” comprises the following meaning: the first node assumes that both a DCI carried by the first control channel candidate and a DCI carried by the second control channel candidate are used to schedule the first signal.

In one embodiment, “a first given control channel candidate being associated with a second given control channel candidate” comprises the following meaning: both a DCI carried by the first given control channel candidate and a DCI carried by the second given control channel candidate are used to schedule a Physical Downlink Shared Channel (PDSCH).

In one embodiment, “a first given control channel candidate being associated with a second given control channel candidate” comprises the following meaning: the first node assumes that both a DCI carried by the first given control channel candidate and a DCI carried by the second given control channel candidate are used to schedule a same PDSCH.

In one embodiment, “a first given control channel candidate being associated with a second given control channel candidate” comprises the following meaning: both a DCI carried by the first given control channel candidate and a DCI carried by the second given control channel candidate are used to schedule a Physical Uplink Shared Channel (PUSCH).

In one embodiment, “a first given control channel candidate being associated with a second given control channel candidate” comprises the following meaning: the first node assumes that both a DCI carried by the first given control channel candidate and a DCI carried by the second given control channel candidate are used to schedule a same PUSCH.

In one embodiment, “a first given control channel candidate being associated with a second given control channel candidate” comprises the following meaning: both a DCI carried by the first given control channel candidate and a DCI carried by the second given control channel candidate are used to trigger a same reference signal.

In one embodiment, “a first given control channel candidate being associated with a second given control channel candidate” comprises the following meaning: the first node assumes that both a DCI carried by the first given control channel candidate and a DCI carried by the second given control channel candidate are used to trigger a same reference signal.

In one embodiment, “a first given control channel candidate being associated with a second given control channel candidate” comprises the following meaning: both a DCI carried by the first given control channel candidate and a DCI carried by the second given control channel candidate are used to schedule a same Transport Block (TB).

In one embodiment, “a first given control channel candidate being associated with a second given control channel candidate” comprises the following meaning: the first node assumes that both a DCI carried by the first given control channel candidate and a DCI carried by the second given control channel candidate are used to schedule a same TB.

In one embodiment, “a first given control channel candidate being associated with a second given control channel candidate” comprises the following meaning: both a DCI carried by the first given control channel candidate and a DCI carried by the second given control channel candidate are two repetitions of a same DCI.

In one embodiment, “a first given control channel candidate being associated with a second given control channel candidate” comprises the following meaning: the first node assumes that both a DCI carried by the first given control channel candidate and a DCI carried by the second given control channel candidate are two repetitions of a same DCI.

In one embodiment, “a first given control channel candidate being associated with a second given control channel candidate” comprises the following meaning: both a DCI carried by the first given control channel candidate and a DCI carried by the second given control channel candidate are two independent transmissions of scheduling information of a same TB.

In one embodiment, “a first given control channel candidate being associated with a second given control channel candidate” comprises the following meaning: the first node assumes that both a DCI carried by the first given control channel candidate and a DCI carried by the second given control channel candidate are two independent transmissions of scheduling information of a same TB.

In one embodiment, “a first given control channel candidate being associated with a second given control channel candidate” comprises the following meaning: both a DCI carried by the first given control channel candidate and a DCI carried by the second given control channel candidate are two of multi-chance transmissions of scheduling information of a same TB.

In one embodiment, “a first given control channel candidate being associated with a second given control channel candidate” comprises the following meaning: the first node assumes that both a DCI carried by the first given control channel candidate and a DCI carried by the second given control channel candidate are two of multi-chance transmissions of scheduling information of a same TB.

In one embodiment, “a first given control channel candidate being associated with a second given control channel candidate” comprises the following meaning: an index of an initial CCE of the first given control channel candidate is related to an index of an initial CCE of the second given control channel candidate.

In one embodiment, “a first given control channel candidate being associated with a second given control channel candidate” comprises the following meaning: an index of an initial CCE of the first given control channel candidate is the same as an index of an initial CCE of the second given control channel candidate.

In one embodiment, “a first given control channel candidate being associated with a second given control channel candidate” comprises the following meaning: an index of an initial CCE of the second given control channel candidate can be inferred according to an index of an initial CCE of the first given control channel candidate.

In one embodiment, “a first given control channel candidate being associated with a second given control channel candidate” comprises the following meaning: the second given control channel candidate can be inferred according to the first given control channel candidate.

In one embodiment, “a first given control channel candidate being associated with a second given control channel candidate” comprises the following meaning: an index of the first given control channel candidate and an index of the second given control channel candidate are associated.

In one embodiment, “a first given control channel candidate being associated with a second given control channel candidate” comprises the following meaning: an index of the first given control channel candidate and an index of the second given control channel candidate have a mapping relation.

In one embodiment, “a first given control channel candidate being associated with a second given control channel candidate” comprises the following meaning: an index of the first given control channel candidate and an index of the second given control channel candidate have a functional relation.

In one embodiment, “a first given control channel candidate being associated with a second given control channel candidate” comprises the following meaning: a CCE occupied by the first given control channel candidate and a CCE occupied by the second given control channel candidate are associated.

In one embodiment, the phrase that “a size of a format of a DCI carried by the first given control channel candidate is the same as a size of a format of a DCI carried by the second given control channel candidate” comprises the following meaning: the first node assumes that a size of a format of a DCI carried by the first given control channel candidate is the same as a size of a format of a DCI carried by the second given control channel candidate.

In one embodiment, the phrase that “a size of a format of a DCI carried by the first given control channel candidate is the same as a size of a format of a DCI carried by the second given control channel candidate” comprises the following meaning: a size of a DCI payload carried by the first given control channel candidate is the same as a size of a DCI payload carried by the second given control channel candidate.

In one embodiment, the phrase that “a size of a format of a DCI carried by the first given control channel candidate is the same as a size of a format of a DCI carried by the second given control channel candidate” comprises the following meaning: a number of bit(s) comprised in a format of a DCI carried by the first given control channel candidate is the same as a number of bit(s) comprised in a format of a DCI carried by the second given control channel candidate.

In one embodiment, the phrase that “a size of a format of a DCI carried by the first given control channel candidate is the same as a size of a format of a DCI carried by the second given control channel candidate” comprises the following meaning: a number of bit(s) comprised in a DCI payload carried by the first given control channel candidate is the same as a number of bit(s) comprised in a DCI payload carried by the second given control channel candidate.

In one embodiment, the phrase that “a DCI carried by the first given control channel candidate” comprises the following meaning: the first node in the present application assumes a DCI carried by the first given control channel candidate.

In one embodiment, the phrase that “a DCI carried by the first given control channel candidate” comprises the following meaning: a DCI actually carried by the first given control channel candidate.

In one embodiment, the phrase that “a DCI carried by the second given control channel candidate” comprises the following meaning: the first node in the present application assumes a DCI carried by the second given control channel candidate.

In one embodiment, the phrase that “a DCI carried by the second given control channel candidate” comprises the following meaning: a DCI actually carried by the second given control channel candidate.

In one embodiment, a format of a DCI carried by the first given control channel candidate is one of 0_0, 0_1,_0_2,_0_3,_1_0,_1_1,_1_2_and_1_3, and a format of a DCI carried by the second given control channel candidate is one of 0_0, 0_1,_0_2,_0_3,_1_0,_1_1,_1_2_and_1_3.

In one embodiment, a format of a DCI carried by the first control channel candidate is the same as a format of a DCI carried by the second control channel candidate.

In one embodiment, a format of a DCI carried by the first control channel candidate is one of all supported DCI formats.

In one embodiment, a format of a DCI carried by the first control channel candidate is one of DCI formats supported by a UE-Specific Search Set (USS set).

In one embodiment, the first control channel candidate belongs to a first search space set, the second control channel candidate belongs to a second search space set, the first search space set is associated with a first control resource set, and the second search space set is associated with a second control resource set.

In one embodiment, a first search space set is a search space set to which the first control channel candidate belongs, and a second search space set is a search space set to which the second control channel candidate belongs.

In one embodiment, the meaning that “the first search space set is associated with a first control resource set” comprises: the first control resource set is a Control Resource Set (CORESET) associated with the first search space set; the meaning that “the second search space set is associated with a second control resource set” comprises: the second control resource set is a CORESET associated with the second search space set.

In one embodiment, the meaning that “the first search space set is associated with a first control resource set” comprises: the first control resource set is a CORESET to which a CCE used by the first search space set belongs; the meaning that “the second search space set is associated with a second control resource set” comprises: the second control resource set is a CORESET to which a CCE used by the second search space set belongs.

In one embodiment, the meaning that “the first search space set is associated with a first control resource set” comprises: the first control resource set is used to determine a CCE used by the first search space set; the meaning that “the second search space set is associated with a second control resource set” comprises: the second control resource set is used to determine a CCE used by the second search space set.

In one embodiment, the meaning that “the first search space set is associated with a first control resource set” comprises: configuration information of the first search space set comprises an index of the first control resource set; the meaning that “the second search space set is associated with a second control resource set” comprises: configuration information of the second search space set comprises an index of the second control resource set.

In one embodiment, the first search space set is the same as the second search space set.

In one embodiment, the first search space set is different from the second search space set.

In one embodiment, the first control resource set is the same as the second control resource set.

In one embodiment, the first control resource set is the same as the second control resource set, and the first TCI state and the second TCI state are two TCI states used by the first control resource set.

In one embodiment, the first control resource set is different from the second control resource set.

In one embodiment, the first search space set is the same as the second search space set, and the first control resource set is different from the second control resource set.

In one embodiment, the first search space set is the same as the second search space set, and the first control resource set is the same as the second control resource set.

In one embodiment, the first search space set is different from the second search space set, and the first control resource set is the same as the second control resource set.

In one embodiment, the first search space set is different from the second search space set, and the first control resource set is different from the second control resource set.

In one embodiment, the first control resource set is a CORESET to which a CCE occupied by the first control channel candidate belongs.

In one embodiment, an index of the first control resource set is a non-negative integer, and an index of the second control resource set is a non-negative integer.

In one embodiment, an index of the first control resource set is a CORESET ID, and an index of the second control resource set is a CORESET ID.

In one embodiment, the second control resource set is a CORESET to which a CCE occupied by the second control channel candidate belongs.

In one embodiment, the meaning that “the first search space set is the same as the second search space set” comprises: an index of the first search space set is equal to an index of the second search space set.

In one embodiment, the meaning that “the first search space set is the same as the second search space set” comprises: an ID of the first search space set is the same as an ID of the second search space set.

In one embodiment, the meaning that “the first search space set is the same as the second search space set” comprises: a higher-layer signaling configures the first search space set or the second search space set.

In one embodiment, the meaning that “the first search space set is different from the second search space set” comprises: an index of the first search space set is not equal to an index of the second search space set.

In one embodiment, the meaning that “the first search space set is different from the second search space set” comprises: an ID of the first search space set is different from an ID of the second search space set.

In one embodiment, the meaning that “the first search space set is different from the second search space set” comprises: the first search space set and the second search space set are separately and independently configured.

In one embodiment, the meaning that “the first search space set is different from the second search space set” comprises: the first search space set and the second search space set are respectively configured by two IEs.

In one embodiment, the meaning that “the first control resource set is the same as the second control resource set” comprises: an index of the first control resource set is equal to an index of the second control resource set.

In one embodiment, the meaning that “the first control resource set is the same as the second control resource set” comprises: an ID of the first control resource set is equal to an ID of the second control resource set.

In one embodiment, the meaning that “the first control resource set is the same as the second control resource set” comprises: a higher-layer signaling configures the first control resource set or the second control resource set.

In one embodiment, the meaning that “the first control resource set is different from the second control resource set” comprises: an index of the first control resource set is not equal to an index of the second control resource set.

In one embodiment, the meaning that “the first control resource set is different from the second control resource set” comprises: an ID of the first control resource set is different from an ID of the second control resource set.

In one embodiment, the meaning that “the first control resource set is different from the second control resource set” comprises: the first control resource set and the second control resource set are separately and independently configured.

In one embodiment, the meaning that “the first control resource set is different from the second control resource set” comprises: the first control resource set and the second control resource set are respectively configured by two IEs.

In one embodiment, the first signal is transmitted through a Physical Downlink Shared Channel (PDSCH).

In one embodiment, the first signal carries a second bit block, and the second bit block comprises a positive integer number of bit(s).

In one embodiment, the first signal comprises S sub-signals, and the S sub-signals carry a second bit block, S being a positive integer greater than 1.

In one embodiment, the S sub-signals are respectively S repetitions of the second bit block.

In one embodiment, the second bit block comprises a positive integer number of TB(s).

In one embodiment, the second bit block comprises a TB.

In one embodiment, the second bit block comprises a positive integer number of Code Block Group(s) (CBG(s)).

In one embodiment, the first signal is obtained by the second bit block sequentially through CRC Insertion, Channel Coding, Rate Matching, Scrambling, Modulation, Layer Mapping, Precoding, Mapping to Resource Element, OFDM Baseband Signal Generation, and Modulation and Upconversion.

In one embodiment, the first signal is obtained by the second bit block sequentially through CRC Insertion, Channel Coding, Rate Matching, Scrambling, Modulation, Layer Mapping, Precoding, Mapping to Virtual Resource Blocks, Mapping from Virtual to Physical Resource Blocks, OFDM Baseband Signal Generation and Modulation and Upconversion.

In one embodiment, the first signal is obtained by the second bit block sequentially through CRC Insertion, Segmentation, CRC Insertion, Channel Coding, Rate Matching, Concatenation, Scrambling, Modulation, Layer Mapping, Precoding, Mapping to Resource Element, OFDM Baseband Signal Generation, and Modulation and Upconversion.

In one embodiment, scheduling information of the first signal comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), DMRS antenna port(s), or an applied Transmission Configuration Indicator (TCI) state.

In one subembodiment of the above embodiment, configuration information of the DMRS comprises at least one of a Reference Signal (RS) sequence, a mapping mode, a DMRS type, occupied time-domain resources, occupied frequency-domain resources, occupied code-domain resources, cyclic shift, or an Orthogonal Cover Code (OCC).

In one embodiment, the first bit block only comprises a HARQ-ACK information bit for the first signal.

In one embodiment, the first bit block comprises a first bit sub-block, and the first bit sub-block comprises a HARQ-ACK information bit for the first signal.

In one subembodiment of the above embodiment, the first bit block only comprises the first bit sub-block.

In one subembodiment of the above embodiment, the first bit block also comprises at least one bit other than the first bit sub-block.

In one embodiment, the HARQ-ACK information bit for the first signal indicates whether the second bit block is correctly received.

In one embodiment, the HARQ-ACK information bit for the first signal indicates whether each bit in the second bit block is correctly received.

In one embodiment, the first control channel candidate carries a first PDCCH used to schedule the first signal, the second control channel candidate carries a second PDCCH used to schedule the first signal, and the first value and the second value are respectively a sequence number of a PDCCH used to schedule the first signal.

In one subembodiment of the above embodiment, the first value is equal to 0, and the second value is equal to 1.

In one subembodiment of the above embodiment, the first value is equal to 1, and the second value is equal to 2.

In one embodiment, the first control channel candidate carries a second PDCCH used to schedule the first signal, the second control channel candidate carries a first PDCCH used to schedule the first signal, and the first value and the second value are respectively a sequence number of a PDCCH used to schedule the first signal.

In one subembodiment of the above embodiment, the first value is equal to 1, and the second value is equal to 0.

In one subembodiment of the above embodiment, the first value is equal to 2, and the second value is equal to 1.

In one embodiment, the first PDCCH used to schedule the first signal is earlier than the second PDCCH used to schedule the first signal on time.

### Embodiment 6

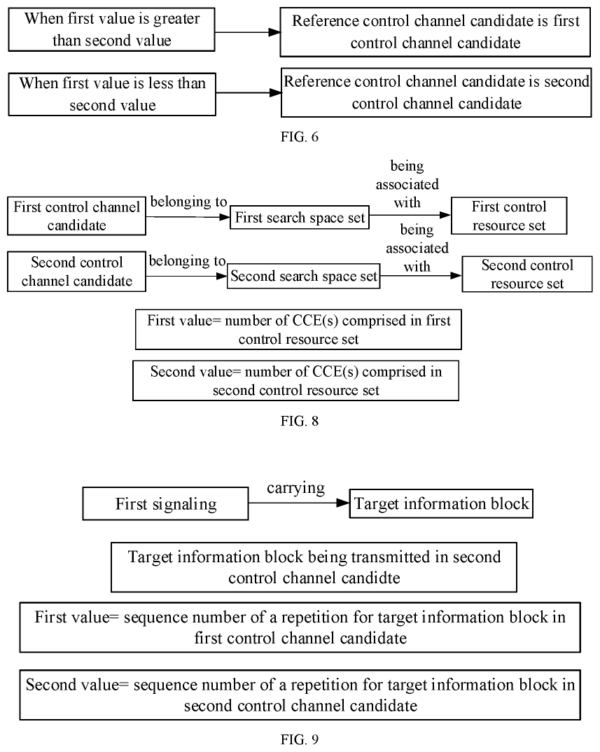

Embodiment 6 illustrates a schematic diagram of determining a reference control channel candidate according to a size relation between a first value and a second value, as shown in FIG. 6.

In embodiment 6, when the first value is less than the second value, the reference control channel candidate is the first control channel candidate; when the first value is greater than the second value, the reference control channel candidate is the second control channel candidate.

### Embodiment 7

Embodiment 7 illustrates another schematic diagram of determining a reference control channel candidate according to a size relation between a first value and a second value, as shown in FIG. 7.

In embodiment 7, when the first value is greater than the second value, and the reference control channel candidate is the first control channel candidate; when the first value is less than the second value, and the reference control channel candidate is the second control channel candidate.

### Embodiment 8

Embodiment 8 illustrates a schematic diagram of a first value and a second value, as shown in FIG. 8.

In embodiment 8, the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set.

In one embodiment, the first search space set comprises a positive integer number of control channel candidate(s), and the first control channel candidate is a control channel candidate in the first search space set; the second search space set comprises a positive integer number of control channel candidate(s), and the second control channel candidate is a control channel candidate in the second search space set.

In one embodiment, the first control resource set comprises a positive integer number of CCE(s), and the second control resource set comprises a positive integer number of CCE(s).

### Embodiment 9

Embodiment 9 illustrates another schematic diagram of a first value and a second value, as shown in FIG. 9.

In embodiment 9, the first signaling carries a target information block, the target information block is transmitted in the second control channel candidate, the first value is a sequence number for a repetition of the target information block in the first control channel candidate, and the second value is a sequence number for a repetition of the target information block in the second control channel candidate.

In one embodiment, the meaning of “the target information block being transmitted in the second control channel candidate” comprises: the first node assumes that the target information block is transmitted in the second control channel candidate.

In one embodiment, the meaning of “the target information block being transmitted in the second control channel candidate” comprises: the target information block is actually transmitted in the second control channel candidate.

In one embodiment, the target information block comprises a DCI.

In one embodiment, the target information block comprises partial fields in a DCI.

In one embodiment, the target information block comprises the scheduling information of the first signal.

In one embodiment, the first control channel candidate is used for a first repetition for the target information block, and the second control channel candidate is used for a second repetition for the target information block; the first value is less than the second value.

In one subembodiment of the above embodiment, the first value is equal to 0, and the second value is equal to 1.

In one subembodiment of the above embodiment, the first value is equal to 1, and the second value is equal to 2.

In one embodiment, the first control channel candidate is used for a second repetition for the target information block, and the second control channel candidate is used for a first repetition for the target information block; the first value is greater than the second value.

In one subembodiment of the above embodiment, the first value is equal to 1, and the second value is equal to 0.

In one subembodiment of the above embodiment, the first value is equal to 2, and the second value is equal to 1.

In one embodiment, the first repetition of the target information block is earlier than the second repetition of the target information block.

### Embodiment 10

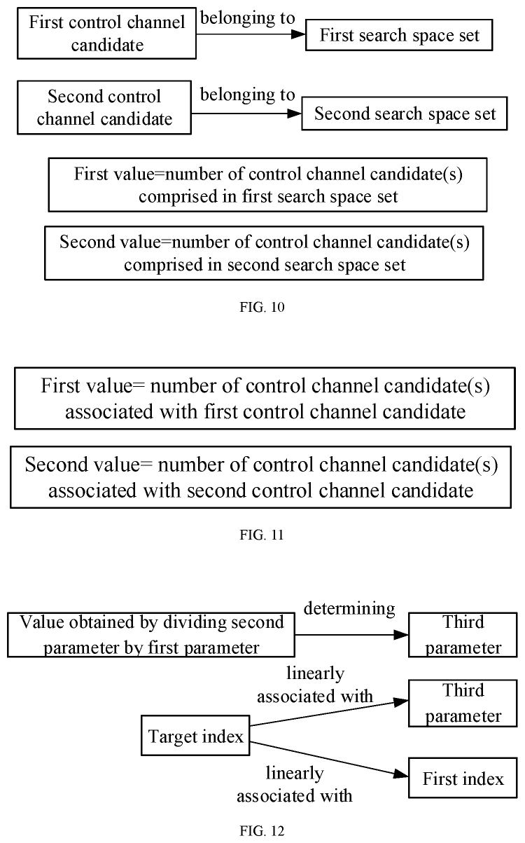

Embodiment 10 illustrates another schematic diagram of a first value and a second value, as shown in FIG. 10.

In embodiment 10, the first control channel candidate belongs to a first search space set, and the second control channel candidate belongs to a second search space set; the first value is equal to a number of control channel candidate(s) comprised in the first search space set, and the second value is equal to a number of control channel candidate(s) comprised in the second search space set.

### Embodiment 11

Embodiment 11 illustrates another schematic diagram of a first value and a second value, as shown in FIG. 11.

In embodiment 11, the first value is a number of control channel candidate(s) associated with the first control channel candidate, and the second value is a number of control channel candidate(s) associated with the second control channel candidate.

In one embodiment, the first control channel candidate belongs to a first search space set, and the second control channel candidate belongs to a second search space set; any control channel candidate associated with the first control channel candidate belongs to the second search space set, and any control channel candidate associated with the second control channel candidate belongs to the first search space set.

In one embodiment, the control channel candidate is a physical-layer control channel candidate.

In one embodiment, the control channel candidate is a physical downlink control channel candidate.

In one embodiment, the control channel candidate is a Monitored PDCCH Candidate.

In one embodiment, the control channel candidate occupies a positive integer number of CCE(s).

In one embodiment, a number of CCE(s) occupied by the first control channel candidate is equal to one of 1, 2, 4, 8 and 16.

### Embodiment 12

Embodiment 12 illustrates a schematic diagram of determining a target index, as shown in FIG. 12.

In embodiment 12, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

In one embodiment, the first parameter is a total number of CCE(s) comprised in a CORESET to which a CCE occupied by the reference control channel candidate belongs.

In one embodiment, when the reference control channel candidate is the first control channel candidate, the first parameter is a total number of CCE(s) comprised in the first control resource set; when the reference control channel candidate is the second control channel candidate, the first parameter is a total number of CCE(s) comprised in the second control resource set.

In one embodiment, the first parameter has a functional relation with N_{CCE,p}.

In one embodiment, the first parameter is N_{CCE,p}.

In one embodiment, for the specific meaning of the N_{CCE,p}, refer to section 9.2.3 in 3GPP 38.213.

In one embodiment, the second parameter is a non-negative integer less than the first parameter.

In one embodiment, the second parameter has a functional relation with n_{CCE,p}.

In one embodiment, the second parameter is n_{CCE,p}.

In one embodiment, the second parameter is n_{CCE,p} mod N_{CCE,p}.

In one embodiment, for the specific meaning of the n_{CCE,p}, refer to section 9.2.3 in 3GPP 38.213.

In one embodiment, the first control channel candidate is used to determine the second parameter.

In one embodiment, an initial CCE of the first control channel candidate is used to determine the second parameter.

In one embodiment, an index of an initial CCE of the first control channel candidate is used to determine the second parameter.

In one embodiment, the second parameter is equal to an index of an initial CCE of the first control channel candidate.

In one embodiment, the second parameter has a functional relation with an index of an initial CCE of the first control channel candidate.

In one embodiment, the second parameter is equal to a non-negative integer obtained by an index of an initial CCE of the first control channel mod the first parameter.

In one embodiment, an index of an initial CCE of the first control channel candidate is n1, the first parameter is N1, and the second parameter is equal to n1 mod N1.

In one embodiment, the reference control channel candidate is used to determine the second parameter.

In one embodiment, an initial CCE of the reference control channel candidate is used to determine the second parameter.

In one embodiment, an index of an initial CCE of the reference control channel candidate is used to determine the second parameter.

In one embodiment, the second parameter is equal to an index of an initial CCE of the reference control channel candidate.

In one embodiment, the second parameter has a functional relation with an index of an initial CCE of the reference control channel candidate.

In one embodiment, the second parameter is equal to a non-negative integer obtained by an index of an initial CCE of the reference control channel mod the first parameter.

In one embodiment, an index of an initial CCE of the reference control channel candidate is n2, the first parameter is N1, and the second parameter is equal to n2 mod N1.

In one embodiment, the third parameter is related to M.

In one embodiment, the third parameter has a functional relation with a value obtained by dividing a second parameter by the first parameter.

In one embodiment, a value obtained by dividing a second parameter by the first parameter is used to determine a third value, and the third parameter is a maximum integer not greater than the third value.

In one subembodiment of the above embodiment, the third value is related to M.

In one subembodiment of the above embodiment, the third value is related to both M and the first index.

In one subembodiment of the above embodiment, a relation between the first index and M is used to determine the third value.

In one subembodiment of the above embodiment, a first reference integer is a non-negative integer obtained by M mod 8, a second reference integer is a value obtained by dividing the second parameter by the first parameter, a third reference integer is a minimum integer of a value obtained by dividing M by 8, and a fourth reference integer is a maximum integer of a value obtained by dividing M by 8; when the first index is less than the first reference integer, the third value is equal to a product of the second reference integer and the third reference integer; when the first index is greater than or equal to the first reference integer, the third value is equal to a product of the second reference integer and the fourth reference integer.

In one subembodiment of the above embodiment, a first reference integer is a non-negative integer obtained by M mod a second threshold, a second reference integer is a value obtained by dividing the second parameter by the first parameter, a third reference integer is a minimum integer not less than a value obtained by dividing M by the second threshold, and a fourth reference integer is a maximum integer not greater than a value obtained by dividing M by the second threshold; when the first index is less than the first reference integer, the third value is equal to a product of the second reference integer and the third reference integer; when the first index is greater than or equal to the first reference integer, the third value is equal to a product of the second reference integer and the fourth reference integer; the second threshold is a positive integer.

In one subembodiment of the above embodiment, the second parameter is n_{CCE,p}, the first parameter is N_{CCE,p}, M is R_{PUCCH}, and the first index is Δ_{PRI}<R_{PUCCH} mod 8, the third value is

$$\frac{{n}_{CCE , p} \cdot ⌈ {R}_{PUCCH} / 8 ⌉}{{N}_{CCE , p}} ,$$

the third parameter is

$$⌊ \frac{{n}_{CCE , p} \cdot ⌈ {R}_{PUCCH} / 8 ⌉}{{N}_{CCE , p}} ⌋ ;$$

when Δ_{PRI}≥R_{PUCCH} mod 8the third value is

$$\frac{{n}_{CCE , p} \cdot ⌊ {R}_{PUCCH} / 8 ⌋}{{N}_{CCE , p}} ,$$

the third parameter is

$$⌊ \frac{{n}_{CCE , p} \cdot ⌊ {R}_{PUCCH} / 8 ⌋}{{N}_{CCE , p}} ⌋ .$$

In one embodiment, the second threshold is equal to 8.

In one embodiment, the second threshold is equal to the first threshold.

In one embodiment, a relation between the first index and M is used to determine the target index.

In one embodiment, a coefficient of linear correlation between the target index and the third parameter is a positive integer.

In one embodiment, a coefficient of linear correlation between the target index and the third parameter is equal to 1.

In one embodiment, a coefficient of linear correlation between the target index and the first index is related to M.

In one embodiment, a first reference integer is a non-negative integer obtained by M mod 8, and a size relation between the first index and the first reference integer is used to determine the target index.

In one embodiment, a first reference integer is a non-negative integer obtained by M mod 8, a third reference integer is the minimum integer not less than a value obtained by dividing M by 8, and a fourth reference integer is a maximum integer not greater than a value obtained by dividing M by 8; when the first index is less than the first reference integer, a coefficient of linear correlation between the target index and the first index is equal to the third reference integer; when the first index is greater than or equal to the first reference integer, a coefficient of linear correlation between the target index and the first index is equal to the fourth reference integer.

In one embodiment, a first reference integer is a non-negative integer obtained by M mod 8, a third reference integer is the minimum integer not less than a value obtained by dividing M by 8, and a fourth reference integer is a maximum integer not greater than a value obtained by dividing M by 8; when the first index is less than the first reference integer, the target index is equal to a sum of the third parameter and fourth parameter, and the fourth parameter is equal to a product of the first index and the third reference integer; when the first index is greater than or equal to the first reference integer, the target index is equal to a sum of the third parameter, the fourth parameter, and the first reference integer, and the fourth parameter is equal to a product of the first index and the fourth reference integer.

In one embodiment, M is R_{PUCCH}, a first reference integer is R_{PUCCH} mod 8, the first index is Δ_{PRI}, a third reference integer is ┌R_{PUCCH}/8┐, and a fourth reference integer is └R_{PUCCH}/8┘; when Δ_{PRI}<R_{PUCCH} mod 8, the target index is equal to

$$⌊ \frac{{n}_{CCE , p} \cdot ⌈ {R}_{PUCCH} / 8 ⌉}{{N}_{CCE , p}} ⌋ + {Δ}_{PRI} \cdot ⌈ {R}_{PUCCH} / 8 ⌉ ;$$

when Δ_{PRI}≥R_{PUCCH} mod 8, the target index is equal to

$$⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + {R}_{PUCCH} mod 8.$$

In one embodiment, a first reference integer is a non-negative integer obtained by M mod a second threshold, and a size relation between the first index and the first reference integer is used to determine the target index, the second threshold being a positive integer.

In one embodiment, a first reference integer is a non-negative integer obtained by M mod a second threshold, a third reference integer is a minimum integer not less than a value obtained by dividing M by the second threshold value, and a fourth reference integer is a maximum integer not greater than a value obtained by dividing M by the second threshold; when the first index is less than the first reference integer, a coefficient of linear correlation between the target index and the first index is equal to the third reference integer; when the first index is greater than or equal to the first reference integer, a coefficient of linear correlation between the target index and the first index is equal to the fourth reference integer; the second threshold is a positive integer.

In one embodiment, a first reference integer is a non-negative integer obtained by M mod a second threshold, a third reference integer is a minimum integer not less than a value obtained by dividing M by the second threshold value, and a fourth reference integer is a maximum integer not greater than a value obtained by dividing M by the second threshold; when the first index is less than the first reference integer, the target index is equal to a sum of the third parameter and fourth parameter, and the fourth parameter is equal to a product of the first index and the third reference integer; when the first index is greater than or equal to the first reference integer, the target index is equal to a sum of the third parameter, the fourth parameter, and the first reference integer, and the fourth parameter is equal to a product of the first index and the fourth reference integer; the second threshold is a positive integer.

### Embodiment 13

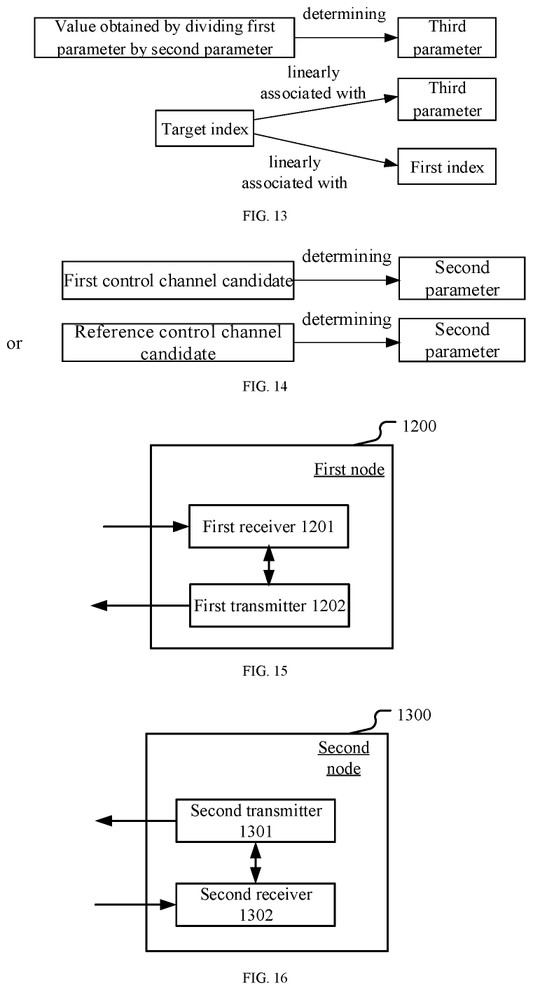

Embodiment 13 illustrates another schematic diagram of determining a target index, as shown in FIG. 13.

In embodiment 13, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

In one embodiment, the first parameter is a non-negative integer less than the second parameter.

In one embodiment, the first parameter has a functional relation with n_{CCE,p}.

In one embodiment, the first parameter is n_{CCE,p}.

In one embodiment, the first parameter is n_{CCE,p}^{mod} N_{CCE,p}.

In one embodiment, the reference control channel candidate is used to determine the first parameter.

In one embodiment, an initial CCE of the reference control channel candidate is used to determine the first parameter.

In one embodiment, an index of an initial CCE of the reference control channel candidate is used to determine the first parameter.

In one embodiment, the first parameter is equal to an index of an initial CCE of the reference control channel candidate.

In one embodiment, the first parameter has a functional relation with an index of an initial CCE of the reference control channel candidate.

In one embodiment, the first parameter is equal to a result of an index of an initial CCE of the reference control channel candidate mod the second parameter.

In one embodiment, an index of an initial CCE of the reference control channel candidate is n2, the second parameter is N2, and the first parameter is n2 mod N2.

In one embodiment, the second parameter has a functional relation with N_{CCE,p}.

In one embodiment, the second parameter is N_{CCE,p}.

In one embodiment, the first control channel candidate is used to determine the second parameter.

In one embodiment, the second parameter is a total number of CCE(s) comprised in the control resource set.

In one embodiment, the reference control channel candidate is used to determine the second parameter.

In one embodiment, the second parameter is a total number of CCE(s) comprised in a CORESET to which a CCE occupied by the reference control channel candidate belongs.

In one embodiment, when the reference control channel candidate is the first control channel candidate, the second parameter is a total number of CCE(s) comprised in the first control resource set; when the reference control channel candidate is the second control channel candidate, the second parameter is a total number of CCE(s) comprised in the second control resource set.

In one embodiment, the third parameter is related to M.

In one embodiment, the third parameter has a functional relation with a value obtained by dividing the first parameter by the second parameter.

In one embodiment, a value obtained by dividing the first parameter by a second parameter is used to determine a third value, and the third parameter is a maximum integer not greater than the third value.

In one subembodiment of the above embodiment, the third value is related to M.

In one subembodiment of the above embodiment, the third value is related to both M and the first index.

In one subembodiment of the above embodiment, a relation between the first index and M is used to determine the third value.

In one subembodiment of the above embodiment, a first reference integer is a non-negative integer obtained by M mod 8, a fifth reference integer is a value obtained by dividing the first parameter by the second parameter, a third reference integer is a minimum integer not less than a value obtained by dividing M by 8, and a fourth reference integer is a maximum integer not greater than a value obtained by dividing M by 8; when the first index is less than the first reference integer, the third value is equal to a product of the fifth reference integer and the third reference integer; when the first index is greater than or equal to the first reference integer, the third value is equal to a product of the fifth reference integer and the fourth reference integer.

In one subembodiment of the above embodiment, the first parameter is n_{CCE,p}, the second parameter is N_{CCE,p}, M is R_{PUCCH}, and the first index is Δ_{PRI}; when Δ_{PRI}<R_{PUCCH} mod 8, the third value is

$$\frac{{n}_{CCE , p} \cdot ⌈ {R}_{PUCCH} / 8 ⌉}{{N}_{CCE , p}} ,$$

the third parameter is

$$⌊ \frac{{n}_{CCE , p} \cdot ⌈ {R}_{PUCCH} / 8 ⌉}{{N}_{CCE , p}} ⌋ ;$$

when Δ_{PRI}≥R_{PUCCH} mod 8, the third value is

$$\frac{{n}_{CCE , p} \cdot ⌊ {R}_{PUCCH} / 8 ⌋}{{N}_{CCE , p}} ,$$

the third parameter is

$$⌊ \frac{{n}_{CCE , p} \cdot ⌊ {R}_{PUCCH} / 8 ⌋}{{N}_{CCE , p}} ⌋ .$$

In one subembodiment of the above embodiment, a first reference integer is a non-negative integer obtained by M mod a second threshold, a fifth reference integer is a value obtained by dividing the first parameter by the second parameter, a third reference integer is a minimum integer not less than a value obtained by dividing M by the second threshold, and a fourth reference integer is a maximum integer not greater than a value obtained by dividing M by the second threshold; when the first index is less than the first reference integer, the third value is equal to a product of the fifth reference integer and the third reference integer; when the first index is greater than or equal to the first reference integer, the third value is equal to a product of the fifth reference integer and the fourth reference integer; the second threshold is a positive integer.

### Embodiment 14

Embodiment 14 illustrates a schematic diagram of determining a second parameter, as shown in FIG. 14.

In embodiment 14, the first control channel candidate is used to determine the second parameter, or the reference control channel candidate is used to determine the second parameter.

In one embodiment, the first control channel candidate is used to determine the second parameter.

In one embodiment, the reference control channel candidate is used to determine the second parameter.

In one embodiment, a value obtained by dividing the second parameter by the first parameter is used to determine the third parameter, and the first control channel candidate is used to determine the second parameter.

In one subembodiment of the above embodiment, an initial CCE of the first control channel candidate is used to determine the second parameter.

In one subembodiment of the above embodiment, an index of an initial CCE of the first control channel candidate is used to determine the second parameter.

In one subembodiment of the above embodiment, the second parameter is equal to an index of an initial CCE of the first control channel candidate.

In one subembodiment of the above embodiment, the second parameter has a functional relation with an index of an initial CCE of the first control channel candidate.

In one subembodiment of the above embodiment, the second parameter is equal to a non-negative integer obtained by an index of an initial CCE of the first control channel mod the first parameter.

In one subembodiment of the above embodiment, an index of an initial CCE of the first control channel candidate is n1, the first parameter is N1, and the second parameter is equal to n1 mod N1.

In one embodiment, a value obtained by dividing the second parameter by the first parameter is used to determine the third parameter, and the reference control channel candidate is used to determine the second parameter.

In one subembodiment of the above embodiment, an initial CCE of the reference control channel candidate is used to determine the second parameter.

In one subembodiment of the above embodiment, an index of an initial CCE of the reference control channel candidate is used to determine the second parameter.

In one subembodiment of the above embodiment, the second parameter is equal to an index of an initial CCE of the reference control channel candidate.

In one subembodiment of the above embodiment, the second parameter has a functional relation with an index of an initial CCE of the reference control channel candidate.

In one subembodiment of the above embodiment, the second parameter is equal to a non-negative integer obtained by an index of an initial CCE of the reference control channel mod the first parameter.

In one subembodiment of the above embodiment, an index of an initial CCE of the reference control channel candidate is n2, the first parameter is N1, and the second parameter is equal to n2 mod N1.

In one embodiment, a value obtained by dividing a first parameter by the second parameter is used to determine a third parameter, and the first control channel candidate is used to determine the second parameter.

In one subembodiment of the above embodiment, the second parameter is a total number of CCE(s) comprised in the control resource set.

In one embodiment, a value obtained by dividing a first parameter by the second parameter is used to determine a third parameter, and the reference control channel candidate is used to determine the second parameter.

In one subembodiment of the above embodiment, the second parameter is a total number of CCE(s) comprised in a CORESET to which a CCE occupied by the reference control channel candidate belongs.

In one subembodiment of the above embodiment, when the reference control channel candidate is the first control channel candidate, the second parameter is a total number of CCE(s) comprised in the first control resource set; when the reference control channel candidate is the second control channel candidate, the second parameter is a total number of CCE(s) comprised in the second control resource set.

### Embodiment 15

Embodiment 15 illustrates a structure block diagram of a processor in a first node, as shown in FIG. 15. In FIG. 15, a processor 1200 in a first node comprises a first receiver 1201 and a first transmitter 1202.

In one embodiment, the first node 1200 is a UE.

In one embodiment, the first node 1200 is a relay node.

In one embodiment, the first node 1200 is a vehicle-mounted communication device.

In one embodiment, the first node 1200 is a UE that supports V2X communications.

In one embodiment, the first node 1200 is a relay node that supports V2X communications.

In one embodiment, the first receiver 1201 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first two of the antenna 452, the transmitter 454, the multi-antenna transmitting processor 457, the transmitting processor 468, the controller/processor 459, the memory 460, and the data source 467 in FIG. 4 of the present application.

The first receiver 1201 receives a first information block; receives a first signaling;

the first transmitter 1202 transmits a first bit block in a first radio resource group;

In embodiment 15, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one embodiment, when the first value is less than the second value, the reference control channel candidate is the first control channel candidate; when the first value is greater than the second value, the reference control channel candidate is the second control channel candidate.

In one embodiment, the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set.

In one embodiment, the first value is a number of control channel candidate(s) associated with the first control channel candidate, and the second value is a number of control channel candidate(s) associated with the second control channel candidate.

In one embodiment, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

In one embodiment, the first control channel candidate is used to determine the second parameter, or the reference control channel candidate is used to determine the second parameter.

In one embodiment, the first receiver 1201 receives a first signal; herein, the first signaling is used to indicate scheduling information of the first signal, and the first bit block comprises a HARQ-ACK information bit for the first signal.

### Embodiment 16

Embodiment 16 illustrates a structure block diagram of a processor in a second node, as shown in FIG. 16.

In FIG. 16, a processor 1300 of a second node comprises a second transmitter 1301 and a second receiver 1302.

In one embodiment, the second node 1300 is a UE.

In one embodiment, the second node 1300 is a base station.

In one embodiment, the second node 1300 is a relay node.

In one embodiment, the second transmitter 1301 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first two of the antenna 420, the receiver 418, the multi-antenna receiving processor 472, the receiving processor 470, the controller/processor 475 and the memory 476 in FIG. 4 of the present application.

The second transmitter 1301 transmits first information block; transmits a first signaling;

the second receiver 1302 receives a first bit block in a first radio resource group;

In embodiment 16, the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

In one embodiment, when the first value is less than the second value, the reference control channel candidate is the first control channel candidate; when the first value is greater than the second value, the reference control channel candidate is the second control channel candidate.

In one embodiment, the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set.

In one embodiment, the first value is a number of control channel candidate(s) associated with the first control channel candidate, and the second value is a number of control channel candidate(s) associated with the second control channel candidate.

In one embodiment, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M.

In one embodiment, the first control channel candidate is used to determine the second parameter, or the reference control channel candidate is used to determine the second parameter.

In one embodiment, the second transmitter 1301 transmits a first signal; herein, the first signaling is used to indicate scheduling information of the first signal, and the first bit block comprises a HARQ-ACK information bit for the first signal.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block; receiving a first signaling; and
a first transmitter, transmitting a first bit block in a first radio resource group;
wherein the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

2. The first node according to claim 1, wherein when the first value is less than the second value, the reference control channel candidate is the first control channel candidate; when the first value is greater than the second value, the reference control channel candidate is the second control channel candidate.

3. The first node according to claim 1, wherein the first control channel candidate belongs to a first search space set, the second control channel candidate belongs to a second search space set, the first search space set is associated with a first control resource set, and the second search space set is associated with a second control resource set; the first value is equal to a number of Channel Control Element(s) (CCE(s)) comprised in the first control resource set, and the second value is equal to a number of CCE(s) comprised in the second control resource set;
or, the first value is a number of control channel candidate(s) associated with the first control channel candidate, and the second value is a number of control channel candidate(s) associated with the second control channel candidate.

4. The first node according to claim 1, wherein a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M;
or, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M; the first control channel candidate is used to determine the second parameter, or the reference control channel candidate is used to determine the second parameter.

5. The first node according to claim 1, wherein the first receiver receives a first signal; wherein the first signaling is used to indicate scheduling information of the first signal, and the first bit block comprises a Hybrid Automatic Repeat request-ACKnowledgement (HARQ-ACK) information bit for the first signal.

6. A second node for wireless communications, comprising:
a second transmitter, transmitting a first information; transmitting a first signaling; and
a second receiver, receiving a first bit block in a first radio resource group;
wherein the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

7. The second node according to claim 6, wherein when the first value is less than the second value, the reference control channel candidate is the first control channel candidate; when the first value is greater than the second value, the reference control channel candidate is the second control channel candidate.

8. The second node according to claim 6, wherein the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set;
or, the first value is a number of control channel candidate(s) associated with the first control channel candidate, and the second value is a number of control channel candidate(s) associated with the second control channel candidate.

9. The second node according to claim 6, wherein a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M;
or, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M; the first control channel candidate is used to determine the second parameter, or the reference control channel candidate is used to determine the second parameter.

10. The second node according to claim 6, wherein the second transmitter transmits a first signal; wherein the first signaling is used to indicate scheduling information of the first signal, and the first bit block comprises a HARQ-ACK information bit for the first signal.

11. A method in a first node for wireless communications, comprising:
receiving a first information block;
receiving a first signaling; and
transmitting a first bit block in a first radio resource group;
wherein the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

12. The method according to claim 11, wherein when the first value is less than the second value, the reference control channel candidate is the first control channel candidate; when the first value is greater than the second value, the reference control channel candidate is the second control channel candidate.

13. The method according to claim 11, wherein the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set;
or, the first value is a number of control channel candidate(s) associated with the first control channel candidate, and the second value is a number of control channel candidate(s) associated with the second control channel candidate.

14. The method according to claim 11, wherein a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M;
or, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M; the first control channel candidate is used to determine the second parameter, or the reference control channel candidate is used to determine the second parameter.

15. The method according to claim 11, comprising:
receiving a first signal;
wherein the first signaling is used to indicate scheduling information of the first signal, and the first bit block comprises a HARQ-ACK information bit for the first signal.

16. A method in a second node for wireless communications, comprising:
transmitting a first information block;
transmitting a first signaling; and
receiving a first bit block in a first radio resource group;
wherein the first signaling occupies a first control channel candidate, and the first control channel candidate is associated with a second control channel candidate; the first control channel candidate corresponds to a first value, the second control channel candidate corresponds to a second value, a reference control channel candidate is determined according to a size relation between the first value and the second value, and the reference control channel candidate is the first control channel candidate or the second control channel candidate; the reference control channel is used to determine a first parameter, the first signaling is used to indicate a first index, the first parameter and the first index are used together to determine a target index, and the target index is used to indicate the first radio resource group from a first radio resource set; the first information block is used to indicate the first radio resource set, the first radio resource set comprises M radio resource groups, and the first radio resource group is one of the M radio resource groups, M being a positive integer greater than 1; the first parameter is a positive integer, the first value is a non-negative integer, and the second value is a non-negative integer.

17. The method according to claim 16, wherein when the first value is less than the second value, the reference control channel candidate is the first control channel candidate; when the first value is greater than the second value, the reference control channel candidate is the second control channel candidate.

18. The method according to claim 16, wherein the first control channel candidate belongs to a first search space set, the second control channel candidate belongs to a second search space set, the first search space set is associated with a first control resource set, and the second search space set is associated with a second control resource set; the first value is equal to a number of CCE(s) comprised in the first control resource set, and the second value is equal to a number of CCE(s) comprised in the second control resource set;
or, the first value is a number of control channel candidate(s) associated with the first control channel candidate, and the second value is a number of control channel candidate(s) associated with the second control channel candidate.

19. The method according to claim 16, wherein a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M;
or, a value obtained by dividing a second parameter by the first parameter is used to determine a third parameter, the target index is linearly associated with the third parameter, and the target index is linearly associated with the first index; the third parameter is a non-negative integer, and the target index is a non-negative integer less than M; the first control channel candidate is used to determine the second parameter, or the reference control channel candidate is used to determine the second parameter.

20. The method according to claim 16, comprising:
transmitting a first signal;
wherein the first signaling is used to indicate scheduling information of the first signal, and the first bit block comprises a HARQ-ACK information bit for the first signal.
